(19) United States
(12) Patent Application Publication
(10) Pub. No.: US 2018/0285872 A1
(43) Pub. Date: Oct. 4, 2018

(54) EXTRANET-BASED TRANSACTION SERVICES NETWORK

(71) Applicant: Experian Health, Inc., Franklin, TN (US)

(72) Inventors: Steven B. Millhouse, Jordan, MN (US); Christopher G. Busch, Maple Grove, MN (US); Nathan Todd Gilman, Edina, MN (US); Sean M. Porter, Plymouth, MN (US); Paul Joseph Hoffman, Mill Valley, CA (US); Jorge Wong, Yorba Linda, CA (US); Jason Michael Considine, Frisco, TX (US); Michael A. Johnson, Hoquiam, WA (US); Anthony Causin Suralta, Puyallup, WA (US); Oscar Valdez, Goodlettsville, TN (US)

(73) Assignee: Experian Health, Inc., Franklin, TN (US)

(21) Appl. No.: 15/475,678

(22) Filed: Mar. 31, 2017

(51) Int. Cl. G06Q 20/40

(52) U.S. Cl. CPC G06Q 20/405

(57) ABSTRACT

Improvements to the distribution and handling of electronic transactions across a distributed system are provided herein. A user interface is provided to a user responsible for one or more ongoing transactions or plans. The user interface is populated with data related to the user and the ongoing transactions. The user interface enables the user to group and manipulate various ongoing transactions and plans, and is populated with data based on the ongoing transactions, the user's historical transactional data, and a profile for the user based on similar users.

### BACKGROUND

It seems that services for consumers are getting more and more expensive every year. These increasing costs present a particular problem for those with little or no pre-arranged assistance available (e.g., savings, insurance) who must expend significant amounts for services. The consumer either must settle in a single transaction, or the service provider will commonly provide a settlement plan for the consumer to settle according to a schedule over a period of time, which can require significant resources (human and computing) to set up.

### SUMMARY

At least one aspect of this patent document is a system for determining a transaction related to an ongoing transaction record using data and user interfaces distributed over an extranet. The system comprises a data store, the data store storing ongoing transactions records related to a consumer records and user records. A processor is in communication with the data store. The processor is programmed to determine maximum and minimum settlement amounts based at least in part on the user records, determine a proposed settlement amount equal to or less than the maximum amount and equal to or more than the minimum amount, generate a user interface, transmit the user interface and the proposed transaction amount to a user related to the ongoing transaction record, and upon receiving confirmation of the settlement amount by the user over the extranet, transmit the confirmed settlement amount to the provider. A server is in communication with the processor, the data store, and the extranet. The server is programmed to transmit the user interface, transmit the proposed settlement amount, and receive data entered through the user interface.

Another aspect of this patent document is a method for determining a settlement related to an account using data and user interfaces distributed over an extranet. The method comprises receiving ongoing transactions data related to a responsible party from a provider over the extranet, receiving user records over the extranet, determining maximum and minimum settlement amounts based on the ongoing transaction data and the user records, determining a proposed settlement amount equal to or less than the maximum amount and equal to or more than the minimum amount, determining a proposed settlement amount equal to or less than the maximum amount and equal to or more than the minimum amount, generating a user interface, transmitting the user interface and the proposed transaction amount to the user over the extranet, and upon receiving confirmation of a settlement amount by the user over the extranet, transmitting the confirmed settlement amount to the provider.

### BRIEF DESCRIPTION OF THE DRAWINGS

FIG. 1 is a schematic block diagram illustrating an extranet-based transaction services network.

FIG. 2 is a schematic block diagram illustrating an example embodiment of a settlement plan processor.

FIG. 3 illustrates a possible graphical user interface generated by a settlement plan processor illustrated in FIG. 2.

FIG. 4 illustrates an alternative embodiment of a user interface generated by a settlement plan processor illustrated in FIG. 2.

FIG. 5 is a flowchart of operations performed by the systems and extranet-based transaction services network illustrated in FIG. 1.

FIGS. 6A-6C are a flowchart of an alternative embodiment of operations performed by the systems and extranet-based transaction services network illustrated in FIG. 1.

FIG. 7 is a schematic block diagram illustrating a computer device included in the systems illustrated in FIGS. 1 and 2.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

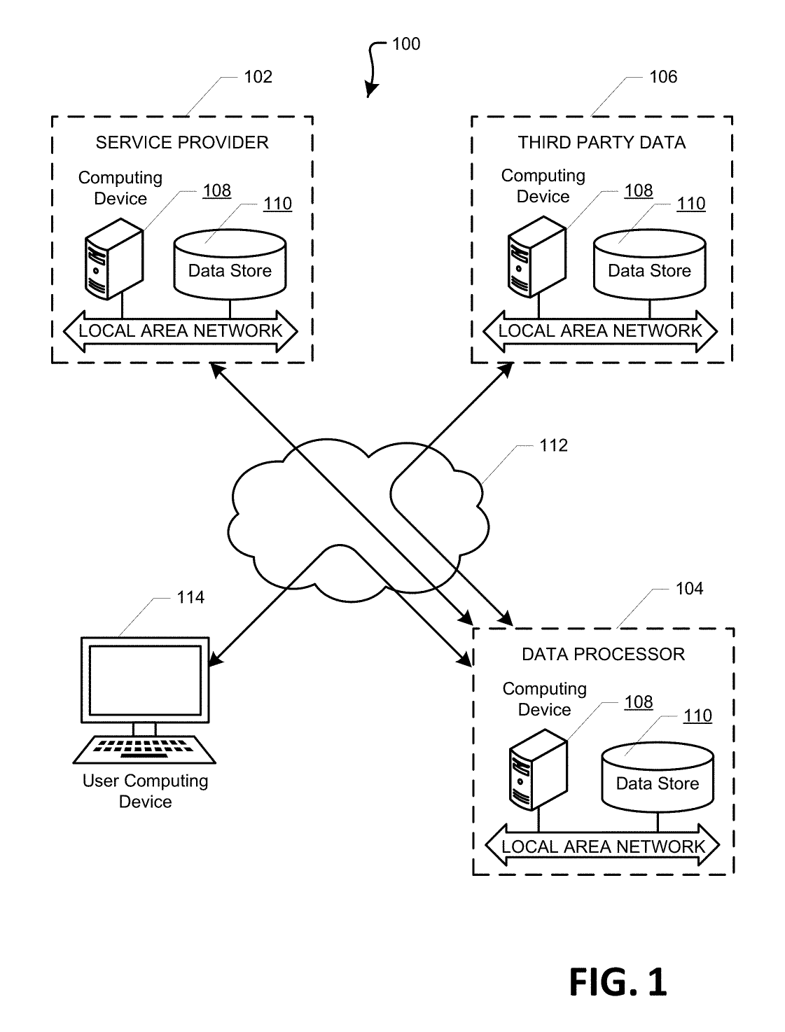

FIG. 1 is a schematic block diagram illustrating an extranet-based transaction services network 100. Systems within the extranet-based transaction services network 100 exchange data and perform analytics to determine a settlement plan that is reasonable for a user profile (e.g., for a guarantor or other responsible entity) profile. Such a settlement plan typically includes a periodic settlement amount and a settlement term or period over which settlements are made. Additionally, systems within the extranet-based transaction services network 100 enable the user to review and adjust the proposed settlement amounts, the proposed settlement term, or both. Determining settlement amounts and terms based on a profile of the user and input from the user minimizes or at least lowers the probability of the users reneging on their obligations as opposed to a system that applies the same set (e.g., a default set) of settlement calculations and terms to all users regardless of their profiles. Additionally, enabling the various systems and computing devices to exchange data over an extranet provides access to data related to a user that might not otherwise be available, and also enables input from the user about acceptable settlement amounts and terms.

The extranet-based transaction services network 100 includes a service provider system 102, a data processor system 104, and one or more third-party data systems 106. Each of the systems 102, 104, 106 include one or more computing devices 108, include one or more data storage devices 110, and are in communication with an extranet 112 for exchanging data and coordinating operations to determine a proposed settlement amount for ongoing transactions (e.g., a receivables account).

A computing device 114 for a user who is a person responsible for settling obligations is also in communication with the extranet-based transaction services network 100. The user can be the consumer receiving services from a service provider, a parent or guardian of the consumer, or any other person or entity responsible for the consumer's obligations regarding services rendered. In different embodiments, the user's computing device 114 can be a computing device 108 in the service provider system 102, can be a personal or home computing device, or can be part of another computing system that is in communication with the extranet 112.

The service provider system 102 stores ongoing transaction records related to consumers. Each ongoing transaction record relates to an encounter with a consumer and contains information related to the service provided to that consumer. The ongoing transaction record includes obligation information for the encounter (e.g., a bill, follow up visits, upcoming additional services). Because each service provider generates an ongoing transaction record for a consumer encounter, there may be multiple ongoing transaction records for each consumer visit to a provider. For example, a consumer may be treated in a hospital and the visit may result in ongoing transaction records from the hospital, the treating physician, and the lab.

The third-party data system(s) 106 tracks and stores information about persons. Examples of such information include historical transaction profiles providing a credit scores and limits; transaction history, and types and frequency of outgoing transactions (e.g., purchases, expenses, outgoing alimony) related to the revolving credit; and incoming transaction (e.g., wages, salary, received alimony) records. The third-party data systems 106 also may track and store demographic information about individuals and communities that are useful for performing analytics about a person or a population of persons. Examples of such demographic information include the number of dependents/children, employers, education level, age, and marital status.

The data processor system 104 is in communication with the service provider system 102, the third-party data system(s) 106, and the user's computing device 114. The exchange of data and interaction between these parts of the extranet- based transaction services network 100 is explained in more detail herein.

The extranet 112 can be any type of public or private data network for communicating data between computer systems at different entities and at different geographic locations. The Internet is an example of one possible extranet 112.

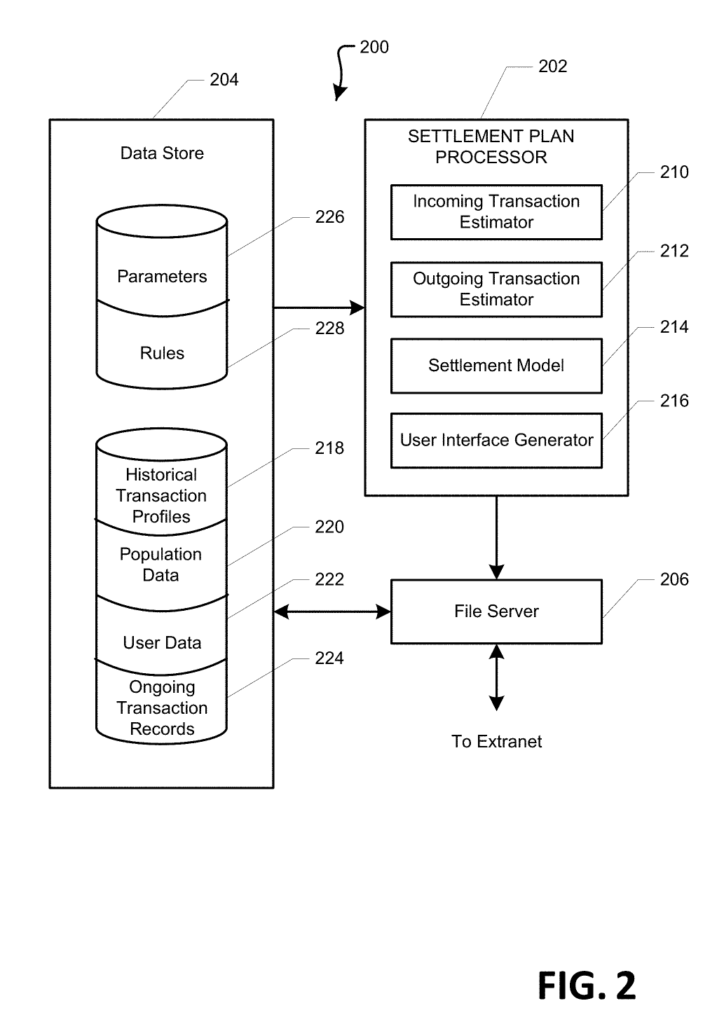

FIG. 2 is a schematic block diagram illustrating an example embodiment of a settlement plan processor 200 that is executed by the data processor system 104. In this example, the settlement plan processor 200 includes a settlement plan processor 202, a data store 204, and a file server 206.

The settlement plan processor 202 comprises an incoming transaction estimator 210, an outgoing transaction estimator 212, a settlement model 214, and a user interface generator 216. The code for the settlement plan processor 202 can be executed by a single computing device. Alternatively, the code for the settlement plan processor 202 can be distributed across two or more computing devices that are in communication with each other and form a part of the data processor system 104.

The incoming transaction estimator 210 is a set of code that analyzes data related to the user and generates an estimate of the user's incoming transactions (e.g., wages, received alimony). In an example embodiment, the estimate can be of the user's adjusted gross incoming transactions, although in alternative embodiments, the estimated incoming transactions can be an amount other than the adjusted gross. In various embodiments, the incoming transactions can be estimated by inquiring with the user through the user's computing device 114. Alternatively, the incoming transactions can be estimated by executing analytical models using data related to user, data related to a population of persons having profiles similar to the user, or combinations thereof.

The outgoing transaction estimator 212 is a set of code that analyzes data related to the user and generates an estimate of the user's fixed outgoing transactions (e.g., utilities, mortgage/rent, outgoing alimony), the user's discretionary outgoing transactions (e.g., recreational habits), or total outgoing transactions including fixed and discretionary outgoing transactions. In various embodiments, the outgoing transactions can be estimated by inquiring with the user through the user's computing device 114. Alternatively, the outgoing transactions can be estimated by executing analytical models using data related to user, data related to a population of persons having profiles similar to the user, or combinations thereof.

The settlement model 214 is a set of code that models a profile of the user and settlement data including a maximum settlement, a minimum settlement, and a proposed settlement in the range from the maximum to the minimum. The maximum settlement is a determined maximum amount the user can make with minimal risk of reneging on obligations. The minimum settlement is a minimum amount that is acceptable to the service provider or other person to whom settlement is obliged. The minimum settlement can be set by the service provider in parameters or rules transmitted from the provider system 102 to the data processor system 104.

In an example embodiment, the proposed settlement is an amount less than the maximum settlement. It is an amount acceptable to the service provider and is not so high that it places a significant enough burden on the user that there is risk of reneging. Additionally, the proposed settlement is determined by analyzing the user's historical transaction record, estimated incoming transactions, estimated outgoing transactions, demographic information, other data related to the user, or combinations thereof. The proposed settlement is related to the settlement term for settling the obligations and on the number of settlements scheduled during the settlement term.

In another embodiment, the settlement model 214 determines the settlement term, which the period or length of time the user has to settle the obligations or the amount obliged as reflected in the ongoing transactions record(s) for which the user is responsible. Determining the settlement term includes determining a maximum period for settlement of the obligations, determining a minimum period for settlement, and determining a proposed period for settlement. The maximum and proposed periods are determined at least in part based on the amounts of the maximum and proposed settlements, respectively. In an alternative embodiment, the settlement model 214 determines the maximum and proposed settlements at least in part based on the maximum and proposed settlement terms, respectively.

The user interface generator 216 generates a user interface to present settlement plan information to the user and includes input controls that enable the user to accept the proposed settlement amount, select an alternative settlement amount, or both. Other embodiments of a user interface include input controls that enable the user to accept a settlement term, select an alternative settlement term, or both. Other embodiments of the user interface include controls for adjusting and accepting both the settlement amount and the settlement term.

The file server 206 is a computing device that provides data communication between the data processor system 104 and the extranet 112. It is programmed to at least: (i) transmit the user interface to the user's computing device 114; and (ii) exchange parameters, rules, data records, and other data between the data processor system 104 and the provider system 102, the third-party data system(s) 106, the user computing device 114, and other remote systems such as cloud storage servers. The file server 206 interfaces with the data store 204, the settlement plan processor 202, and other software and hardware components of the data processor system 104.

The data store 204 can include memory that forms a part of a computing device or devices executing the transaction plan processor 202. Alternatively, the data store 204 can include separate or secondary storage hardware in communication with the computing device executing the transaction plan processor 202. In various embodiments, the data store 204 can be a cloud-based storage system that is separate and remote from the data processor system 104, but is in communication with the data processing system 104 through the extranet 112.

The data store 204 stores one or more historical transaction profiles 218 about the user (e.g., credit history, prior settlement plans), population data 220, additional user data 222 (e.g., user profile settings, email address), ongoing transactions records 224 for which the user is responsible, parameters 226, and rules 228. The historical transaction profiles 218 are profiles of the user and are received from the third-party data system(s) 106. The user data 222 is received from the third-party data system(s) 106. Examples of user data 222 include additional transactional data and demographic data. The ongoing transaction records 224 are received from the service provider system 102 regarding settled and unsettled ongoing transactions. The population data 220 are received from third-party data systems 106. Examples of population data 220 include data about a population of persons such as transactional and demographic data. The population data 220 may include data about the user, but in other embodiments the population data does not include data about the user. The parameters 226 and rules 228 are used for determining minimum and maximum settlement amounts, proposed settlements, minimum and maximum settlement terms, and proposed settlement terms. For example, the parameters 226 and rules 228 can be used by the outgoing transaction estimator 212, the incoming transaction estimator 210, and the user interface generator 216. Parameters 226 and rules 228 can be generated by the data processor system 104, generated by and received from the provider system 102, or generated by and received from the third-party data system(s) 106. Parameters 226 and rules 228 also can be defined by and received from the user's computing device 114.

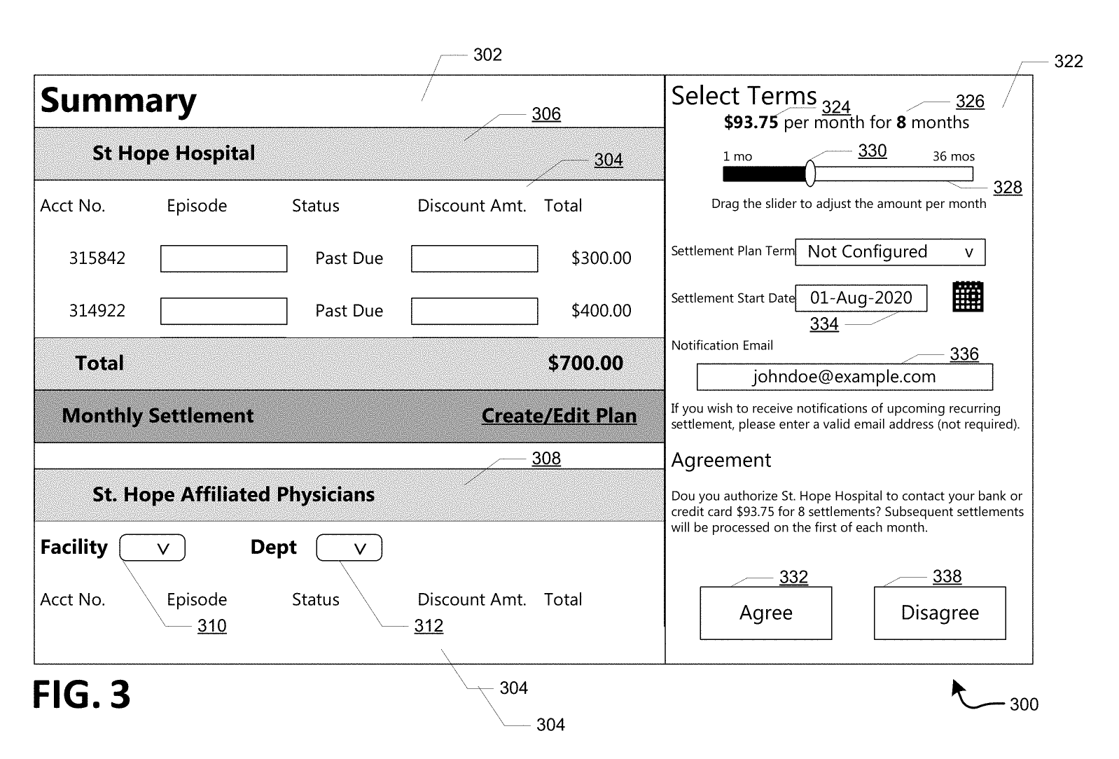

FIG. 3 illustrates one possible graphical user interface 300 that is generated by the user interface generator 216 and then transmitted to the user's computing device 114.

The user interface 300 presents a page presenting information about the consumer, the ongoing transaction records, and other information. A menu (not shown) is embedded in a banner across the top of the user interface 300. The menu includes menu items and controls for selecting which page to display and initiating various operations. Each page will display different information related to things such as findings and information about the consumer, demographic information about the consumer, consumer history, pre-arranged assistance information (e.g., insurance, guarantor, charity services), and ongoing transactions records or other transactional information for the consumer. One operation that can be initiated through the menu is the generation and display of proposed settlement amounts and settlement terms for amount obliged for the ongoing transaction records 224 for which the user is responsible.

In the example illustrated in FIG. 3, the user interface 300 displays an summary page 302, which has a summary of ongoing transactions 304 in which each ongoing transaction for the user is display including a description of the services provided, the status of the ongoing transaction, and modifiers applied to the ongoing transaction, and the total amount to satisfy for the ongoing transaction. The summary of ongoing transactions includes a first header 306 that identifies the provider generating the ongoing transactions. In this example, the provider is the facility or business entity providing services. The provider in this example is a hypothetical “St. Hope Hospital.”

The summary page 302 includes a second header 308 that identifies another provider. In this example, the second header 308 identifies the service provider as a physicians group affiliated St. Hope Hospital. Pull down menus 310 and 312 under the second header 308 enable a user to view details about the provider. Once the details are selected for display under the second header 308, the user interface 300 will display summaries of the ongoing transaction records related to those details.

The user interface 300 also includes menu items or buttons (not shown) for displaying a pop-up window for generating a revised settlement amount and settlement term, or to add new ongoing transactions records to an existing settlement plan. The user interface 300 includes separate controls (not shown), each associated with a separate service provider. When actuated, each such control initiates display of a separate pop-up window tailored to the related, individual service provider.

The pop-up display 322 displays a proposed settlement amount 324 and a proposed settlement term 326 as determined by the settlement model 214 in the settlement plan processor 202. It also displays a slider 328 that has a scale ranging from a minimum settlement term to a maximum settlement term. The slider 328 has a thumb or pointer 330 and the position of the thumb 330 along the slider 328 corresponds to the proposed transaction amount 324. A user can move the thumb 330 to adjust the settlement term 326. The amount of the proposed settlement 324 will change in response to changing the proposed settlement term 326, with the settlement amount 324 increasing as the settlement term 326 gets shorter and the settlement amount 324 decreasing as the settlement term 326 gets longer.

In an example embodiment, the calculation to determine a new proposed settlement amount 324 in response to changing the proposed settlement term 326 is performed by code downloaded to the user's computing device 114 with the user interface 300. In an alternative example, the selected value for the proposed settlement term 326 is transmitted to the data processor system 104 and the settlement model 214 recalculates the proposed settlement amount 324, which then is transmitted back to the user's computing device 114 for display in the pop-up window 322.

When the user is ready to accept the proposed settlement amount and the proposed settlement term, the user actuates an acceptance button 332. The proposed settlement amount 324, proposed settlement term 326, and acceptance thereof are then transmitted to the data processing system 104 where they are stored in the data store 204 as user data 222. The proposed settlement amount 324 is now an accepted settlement amount and the proposed settlement term is now an accepted settlement term. In example embodiments, the data processor system 104 maintains the accepted settlement amount and accepted settlement term, and handles the related communications with the user related to the settlement plan and ongoing transaction records. In other examples, the data processor system 104 transmits the accepted settlement amount and settlement term to the service provider system 102 or to a third-party data system(s) 106 that handles the related communications with the user related to the settlement plan and ongoing transaction records.

Other user interface elements displayed in the pop-up window 322 include a date field 334, an e-mail field 336, and a rejection button 338. The date field 334 is a field in which the user can enter a start date for the settlement term 326. The settlement plan processor 202 may set limits on a range of dates that are acceptable for the minimum settlement term and the maximum settlement term. The date limits can be determined by rules or parameters set by the service provider or some other entity such as an entity handling recovery for the ongoing transactions according to the settlement plan.

The e-mail field 336 is a field where the user enters an e-mail address for receiving electronic communications, notifications, and messages. In an example embodiment, the user can leave this field blank if the user does not want to receive such information via e-mail. The rejection button 338 is a button the user can actuate to reject the proposed settlement amount 324 and proposed settlement term 326. Upon rejecting the proposed settlement amount 324 and proposed settlement term 326, the settlement module 214 can determine an alternative proposed settlement amount and settlement term and send them to the user's computing device 114 for display in the pop-up window 322. Alternatively, the user will be responsible for settling the entire amount of any ongoing transaction in a single settlement, reject responsibility for the ongoing transaction, or be left to determine the settlement amount and settlement term through some other process.

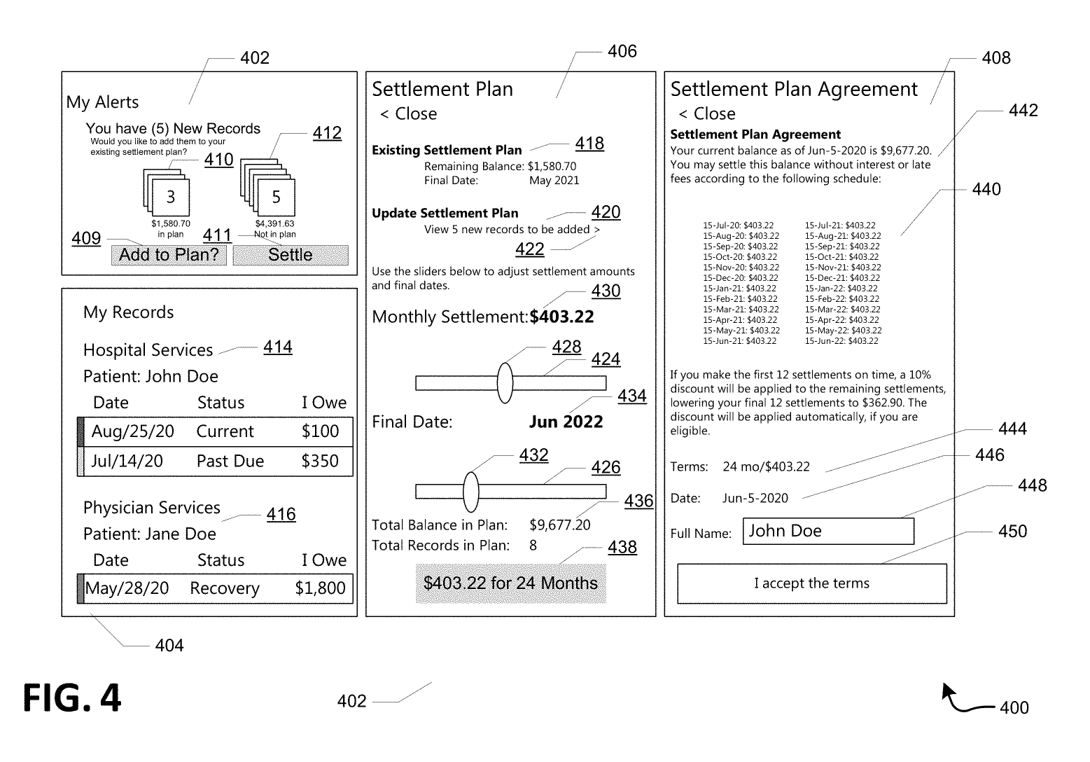

FIG. 4 illustrates an alternative embodiment of a user interface. In this example, a user interface 400 includes a plan summary section 402 (entitled “My Alerts” in the illustrated example), a record summary section 404 (entitled “My Records” in the illustrated example), a settlement plan section 406, and settlement plan agreement section 408.

The plan summary section 402 includes a summary of the records related to the user. In this example, the plan summary section 402 includes a first icon 410 indicating the number of ongoing transaction records currently in the user's settlement plan and the total amount of those ongoing transaction records. The plan summary section 402 also includes a second icon 412 indicating the number of ongoing transactions related to the user, but not yet in a settlement plan and the total amount of those ongoing transaction records.

The plan summary section 402 also includes a user control 409 that when activated presents additional user controls (not shown) for selecting which ongoing transactions not currently in the user's settlement plan that the user would like to add to the settlement plan. For those ongoing transactions selected to add to the settlement plan, the user interface 400 provides controls for selecting a settlement amount and settlement term as discussed in more detail herein. For ongoing transactions that the user does not add to the settlement plan, the user interface 400 includes a button 411 the user can actuate to display an interface for settling the aggregate amount for the ongoing transaction not being added to the settlement plan.

The records summary section 404 identifies the status and amounts related for each ongoing transaction record outstanding. Each ongoing transaction record is displayed under a header 414 and 416 identifying the service provider providing services related to the ongoing transaction record. Each individual ongoing transaction record displayed in the record summary section 404 displays the date of the service, the recovery status of the ongoing transaction record, and the amount due for the ongoing transaction record.

The settlement plan section 406 includes a summary 418 of the existing settlement plan showing the aggregate remaining in the existing settlement plan, and the final date for the settlement plan. The transaction plan section 406 also includes an update interface 420 for updating the settlement plan. The update interface 420 can be used by the user to modify the settlement plan to include new ongoing transactions as selected in the plan summary section 402; create a new settlement plan including ongoing transactions selected in the plan summary section 402; or modify the settlement amount and settlement term in an existing settlement plan without adding any new ongoing transaction records to the settlement plan. A service provider or interested entity can create rules 228 prohibiting modification of an existing plan without adding new ongoing transactions.

The settlement plan section 406 also includes a button 422 that displays the number of new records to be added to the settlement plan. Actuating the button 422 causes the user interface 400 to display the new ongoing transaction records to be added to the settlement plan. In another embodiment, actuating the button 422 presents additional user controls (not shown) for selecting which ongoing transaction records not currently in the user's settlement plan that the user would like to add to the settlement plan. This functionality for adding new ongoing transaction records is substantially similar to the control 409 in the transaction plan section 402 for selecting new ongoing transaction records to add to the settlement plan. In further embodiments, the functionality of adding new ongoing transaction records to the settlement plan can be initiated by the user control 409, the button 422, or both the user control 409 and the button 422 at the discretion of the user.

The settlement plan section 406 has adjustable user interface controls including a settlement amount slider 424 and a settlement term slider 426. The settlement amount slider 424 is scaled with a range from a maximum settlement amount to a minimum settlement amount and a thumb 428 positioned along the slider at a location corresponding the proposed settlement amount. A data field 430 corresponding to the settlement amount slider 424 presents the proposed settlement amount. The settlement term slider 426 is scaled with a range from an earliest final date to the latest final date. The earliest final date and the latest final date define the settlement term. The settlement term slider 426 also has a thumb 432 positioned along the slider at a location corresponding to the proposed final date. The final date defines the settlement term based on the beginning date of the settlement term, which can be the date the settlement plan is accepted by the user, although in alternative embodiments the beginning date of the settlement term can be a date other than the date the settlement plan was accepted by the user. A data field 434 corresponding to the transaction slider 426 presents the final date for the proposed settlement plan.

The user can adjust the proposed settlement by moving the thumb 428 on the settlement amount slider 424. Adjusting the proposed settlement amount causes the proposed final date to automatically adjust so the aggregate amount of the ongoing transactions will be settled by the new proposed final date. Alternatively, the user can adjust the proposed final date by moving the thumb 432 on the settlement term slider 426. Adjusting the proposed final date will cause the proposed settlement amount to be automatically adjusted so the aggregate amount of the ongoing transactions in the settlement plan will be settled on the new proposed final date.

The proposed settlement amount displayed in the data field 424 and the proposed settlement term displayed in the data field 434 at least partially define a proposed settlement plan. A summary 436 of the proposed settlement plan presents the total amount under the proposed settlement plan and the number of ongoing transactions in the proposed settlement plan.

A button 438 displays the proposed settlement amount and settlement term. Actuating the button 438 causes the settlement plan agreement section 408 to be populated with details about the proposed settlement plan.

The settlement plan agreement section 408 lists the aggregate amount of the proposed settlement plan, which corresponds to the aggregate amount due under all of the ongoing transaction records including any ongoing transactions already in the settlement plan and any ongoing transactions newly added to the settlement plan. It also lists a settlement schedule 440 for the proposed settlement plan including the dates settlements are to be made and the associated amounts.

The settlement plan agreement section 408 also includes notes 442 related to the settlement plan, data fields 444 displaying the settlement amount and the settlement term selected by the user, the current date 446 that the user is interacting with the user interface 400, a field 448 to enter the user's full name as verification of the user's identity, and a button 450 the user actuates to accept the settlement amount and the settlement term. The field 448 to enter data verifying the user's identity can include fields for entering data in addition to the user's name to provide further verification the user's identity.

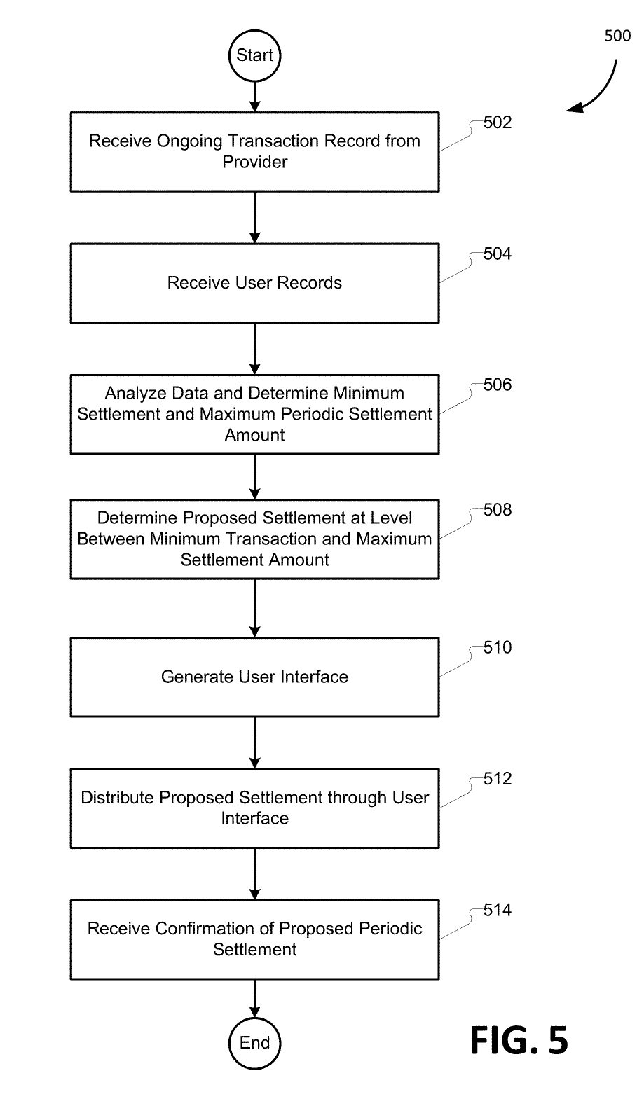

FIG. 5 is a flowchart illustrating a method 500 of operation of the extranet-based transaction services network 100 for proposing and determining settlements and the settlement plan processor 202. The process can be initiated by the provider system 102, a third-party recovery specialist, or a user. The system or computing device for the party initiating the method 500 sends a command to the data processor system 104, which is then processed and acted upon by the data processor system 104.

The data processor system 104 receives ongoing transaction records from the provider system 102. OPERATION 502. The data processor system 104 also receives the historical transaction profile for the user from a third-party data system(s) 106. OPERATION 504. The transaction plan processor 202 analyzes the ongoing transaction records and the user's historical transaction profile and determines a minimum settlement amount and a maximum settlement amount for the user. OPERATION 506. The settlement plan processor 202 then determines a proposed settlement amount. OPERATION 508.

In alternative embodiments, the transaction plan processor 202 can use data related to the user in addition to the ongoing transaction records and historical transaction profile to determine the minimum settlement, maximum settlement, and proposed settlement amount. Examples of such additional data include demographic data and past transactional data.

A user interface 300 or 400 is generated, OPERATION 510, and populated with data and user interface controls related to the maximum settlement, minimum settlement, and proposed settlement. OPERATION 512. The settlement plan processor 202 then controls the file server 206 to transmit the user interface 300 or 400 to the user's computing device 114.

Upon the user accepting the proposed settlement amount, OPERATION 514, the user's computing device 114 sends an instruction to the provider system 102 confirming an actual accepted settlement amount. The actual accepted settlement amount and any other relevant information related to the settlement plan are then stored in the data store 208 as user data 222. Additionally, the provider system 102 can then control recovery of settlements related to the settlement plan. The method 500 then ends.

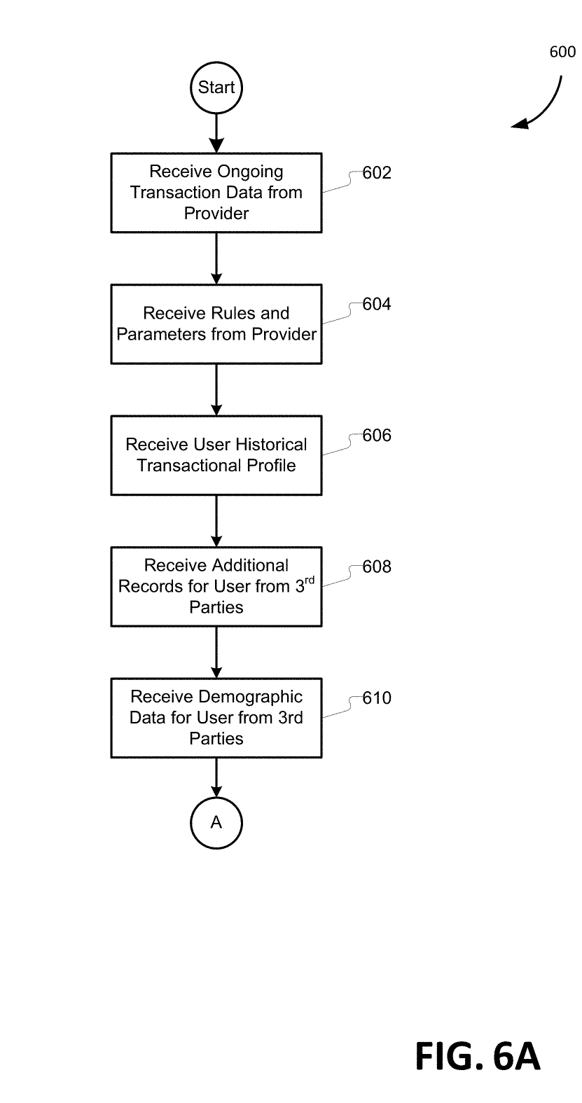

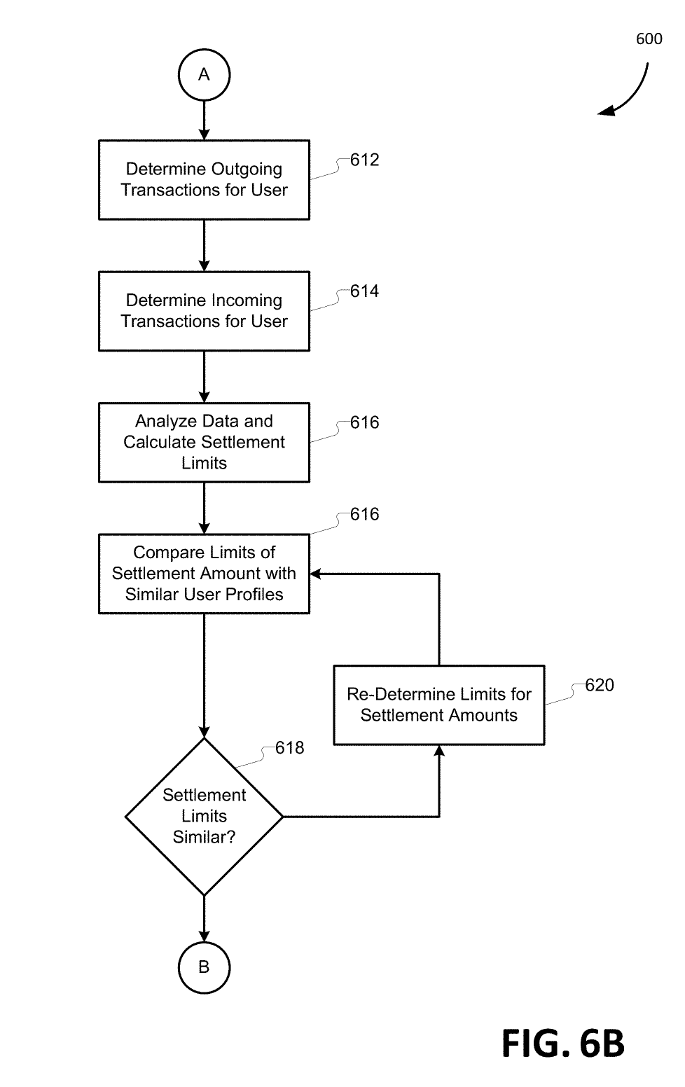

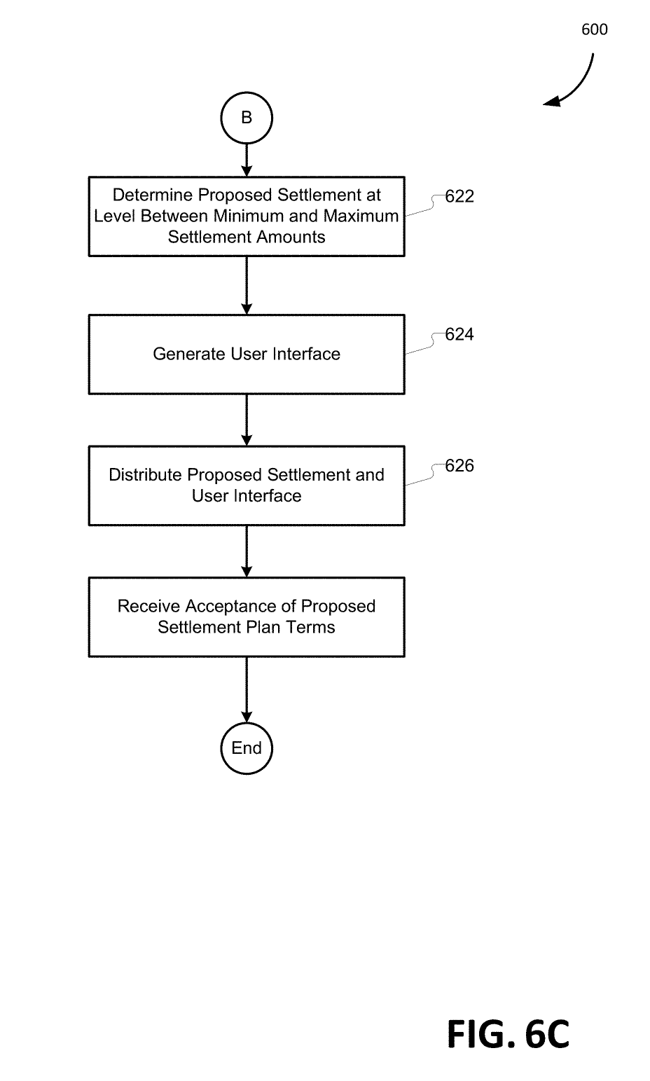

FIGS. 6A-6C are a flow chart illustrating an alternative method 600 for operation of the extranet-based transaction services network 100 for proposing and determining settlements and the settlement plan processor 202.

The method 600 can be initiated by the provider system 102, a third-party recovery specialist, or a user. The system or computing device for the party initiating the method 600 sends a command to the data processor system 104, which is then processed and acted upon by the data processor system 104.

The data processor system 104 requests ongoing transaction records and data related to the user from the provider system 102. OPERATION 602. The provider system 102 also can provide the data processor system 104 with parameters 226 and with rules 228, which are statements that constrain the estimators and models executed by the settlement plan processor 202. OPERATION 604. An example rule 228 might be a statement that limits the settlement period to a maximum length of time and a parameter 226 might be the value defining the maximum settlement period. Different service providers can determine and provide different rules 228. Additionally, the same provider can provide different rules 228 and different parameters 226 for different users of its ongoing transaction records. For example, a provider might provide different maximum settlement term for users with different historical transaction scores.

The processor system 104 receives a historical transaction profile for the user. OPERATION 606. The data processor system 104 further receives additional transactional information about the user from the third-party data source 106, OPERATION 608, and demographic data about the user, OPERATION 610. In another embodiment, the settlement plan processor 202 can receive from third-party data systems 106 transactional and demographic data about a population of persons who have similar transactional and demographic profiles as the user.

Turning now to FIG. 6B, the data processor system 104 determines an estimate of the user's outgoing transactions, OPERATION 612, and determines an estimate of the user's incoming transactions. OPERATION 614. The outgoing transactions estimate can include an estimate of the user's discretionary outgoing transactions, fixed outgoing transactions, or a combination thereof. The outgoing transactions estimate is based on transactional and demographic data of the user and the transactions of a population of persons who have similar transactional and demographic profiles as the user. Similarly, the incoming transactions estimate can be based on transactional and demographic data of the user and the incoming transactional data of a population of persons who have transactional and demographic profiles similar to the user.

The data processor 104 analyzes the ongoing transactions data, the user's historical transactional profile, and estimated outgoing and incoming transactions, and then determines a minimum settlement amount and a maximum settlement amount for the user. OPERATION 616. It then compares the maximum and minimum settlements determined for the user to maximum and minimum settlements amounts that would apply to persons in a population having similar transactional and demographic profiles as the user. OPERATION 618. If the user's maximum and minimum settlements deviate from the maximum and minimum settlements that apply to the population of persons by more than a determined threshold amount, the settlement model 214 determines new maximum and minimum settlements. OPERATION 620. The determined threshold amount can be a fixed value, a proportion of the aggregate amount, a standard deviation, or some other measure.

Turning now to FIG. 6C, if the user's maximum and minimum settlements deviate from the maximum and minimum settlements that apply to the population of persons by less than the determined threshold amount, the settlement model 214 determines a proposed settlement amount between the identified minimum and maximum settlement amounts. OPERATION 622.

The transaction model 214 also can determine a settlement term, including a maximum settlement term, a minimum settlement term, and a proposed settlement term using operations similar to OPERATIONS 616, 618, 620, and 622. As discussed herein, determination of the maximum, minimum, and proposed settlement terms and determination of the maximum, minimum, and proposed settlement amounts affect one another.

A user interface 300 or 400 is generated and populated with data and user interface controls related to the maximum settlement, minimum settlement, and proposed settlement. OPERATION 624. The settlement plan processor 202 then controls the file server 206 to distribute the user interface 300 or 400 to the user's computing device 114. OPERATION 626.

Upon the user accepting the proposed settlement amount, the user's computing device 114 sends an instruction to the processor system 104 confirming an actual settlement amount. The actual settlement amount and any other relevant terms related to the settlement plan are then received by the processor system 104, OPERATION 628, and stored in the data store 206 as user data 222. Additionally, the processor system 104 can then control recovery of settlements for the settlement plan. Alternatively, the data processor system 104 can control the actual settlement amount, and other terms of the settlement plan, to be transmitted to the provider system 102 or a third-party data system(s) 106 for recovery. The method 600 then ends.

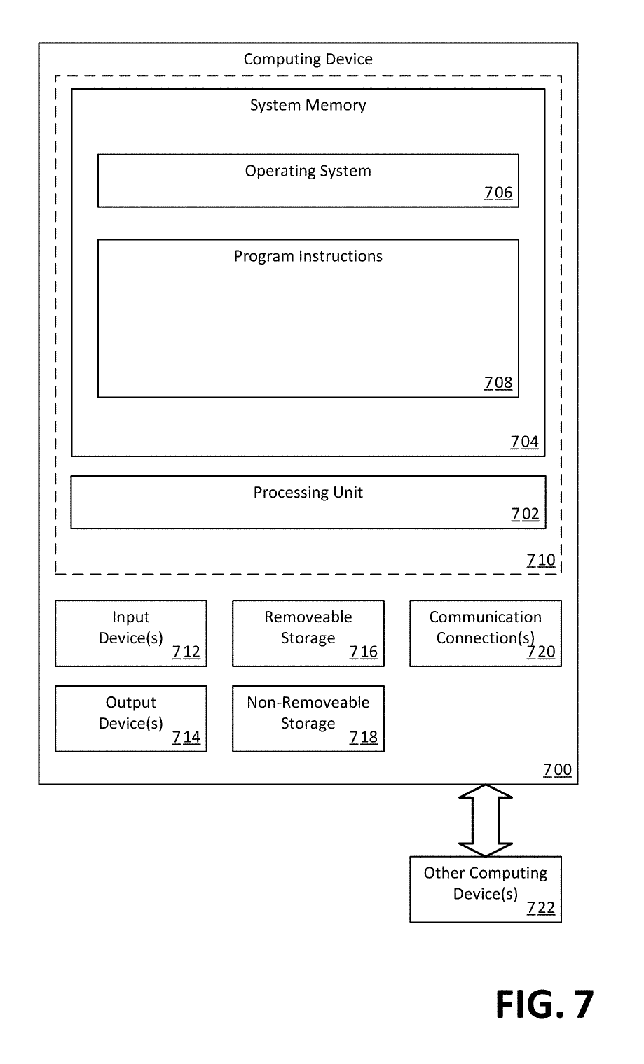

FIG. 7 is a schematic block diagram illustrating components of an example computing device 700 (also 108, 114) with which aspects may be practiced. The computing device 700 may include at least one processing unit 702 and a system memory 704. The system memory 704 may include volatile (e.g. random access memory (RAM)), non-volatile (e.g. read-only memory (ROM)), flash memory, or any combination thereof. System memory 704 may include an operating system 706, one or more program instructions 708, and may include sufficient computer-executable instructions for operating the extranet-based transaction services network 100, including all of the functionality and methods 500 and 600 disclosed herein. Operating system 706, for example, may be suitable for controlling the operation of the computing device 700. Furthermore, aspects may be practiced in conjunction with a graphics library, other operating systems, or any other application program and is not limited to any particular application or system. This basic configuration is illustrated by those components within a dashed line 710. The computing device 700 also may include one or more input device(s) 712 (keyboard, mouse, pen, touch input device, etc.) and one or more output device(s) 714 (e.g., display, speakers, a printer, etc.).

The computing device 700 also may include additional data storage devices (removable or non-removable) such as, for example, magnetic disks, optical disks, or tape. Such additional storage is illustrated by a removable storage 716 and a non-removable storage 718. Computing device 700 also may contain a communication connection 720 that may allow computing device 700 to communicate with other computing devices 722, such as over a network in a distributed computing environment, for example, an intranet or an extranet such as the Internet. Communication connection 720 is one example of a communication medium, via which computer-readable transmission media (i.e., signals) may be propagated.

Programming modules may include routines, programs, components, data structures, and other types of structures that may perform particular tasks or that may implement particular abstract data types. Moreover, aspects may be practiced with other computer system configurations, including the file server 206, hand-held devices, multiprocessor systems, microprocessor-based or programmable user electronics, minicomputers, mainframe computers, and the like. Aspects may also be practiced in distributed computing or server environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data also can be stored on or read from other types of computer-readable media, such as secondary storage devices, like hard disks, floppy disks, or a CD-ROM, or other forms of RAM or ROM. The term computer- readable storage medium refers only to devices and articles of manufacture that store data or computer-executable instructions readable by a computing device. The term computer-readable storage media do not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 700 or any other computing devices 722, in combination with computing device 700, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the invention as claimed in any way. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of example embodiments in the present application, one skilled in the art may envision variations, modifications, and alternate embodiments falling within the spirit and scope of the claims appended hereto.

1. A system for determining a periodic settlement related to an ongoing transaction using data and user interfaces distributed over an extranet, the system comprising:
a data store, the data store storing information including consumer records and user records; and
a processor in communication with the data store, the processor configured to:
determine maximum and minimum periodic settlement amounts based at least in part on the user records;
determine a proposed periodic settlement amount equal to or less than the maximum amount and equal to or more than the minimum amount;
generate a user interface;
transmit the user interface and the proposed periodic settlement amount to a user related to the ongoing transaction record over the extranet; and
upon receiving confirmation of the proposed periodic settlement amount by the user over the extranet, transmit the confirmed settlement amount to the provider.

2. The system of claim 1, wherein the user interface comprises:
an adjustable user input control, the adjustable user input control comprising an indicator, the indicator identifying a settlement amount, the indicator being adjustable from a lower limit corresponding to the minimum settlement amount to an upper limit corresponding to the maximum settlement amount; and
a submission control, upon actuation the submission control programmed to transmit the identified transaction amount to the server.

3. The system of claim 2, wherein the processor is further configured to:
determine a settlement term, the settlement term corresponding to the proposed periodic settlement amount; and
modify the settlement term in response to the identified settlement amount.

4. The system of claim 1, wherein the processor is further configured to determine a range of settlement terms and a proposed settlement term, the range of settlement terms extending from a first length of time to a second length of time, and wherein the user interface comprises:
an adjustable user input control, the adjustable user input control comprising an indicator, the indicator identifying a term for settlement of the proposed settlement amount, the indicator being adjustable from the first length of time to the second length of time; and
a submission control, upon actuation the submission control programmed to transmit the identified term for settlement.

5. The system of claim 4, wherein the proposed periodic settlement amount corresponds to the proposed settlement term, and the processor is further configured to modify the proposed periodic transaction amount in response to the identified term for settlement received from the user interface.

6. The system of claim 1, wherein the maximum and minimum settlement amounts are based at least in part on the user's historical transaction profile.

7. The system of claim 6, wherein the data store further stores demographic data related to the user and the maximum and minimum settlement amounts are based at least in part on the user's demographic data.

8. The system of claim 7, wherein:
the processor is further configured to generate an estimate of the user's outgoing transactions; and
the maximum and minimum settlement amounts are based at least in part on the user's estimated outgoing transactions.

9. The system of claim 8, wherein the processor is further configured to:
compare the estimated outgoing transactions with estimated outgoing transactions of other persons with similar transactional profiles in the data store; and
upon the user's estimated outgoing transactions being different than the outgoing transactions of the other persons with similar transactional profiles by more than a determined threshold amount, re-estimating the user's outgoing transactions.

10. The system of claim 8, wherein:
the processor is further configured to generate an estimate of the user's incoming transactions; and
the maximum and minimum settlement amounts are based at least in part on the user's estimated incoming transactions.

11. The system of claim 8, wherein the processor is further configured to:
compare the estimated incoming transactions with estimated incoming transactions of other persons with similar transactional profiles in the data store; and
upon the estimated incoming transactions being different than the user's estimated incoming transactions of the other persons with similar transactional profiles by more than a determined threshold amount, re-estimating the user's incoming transactions.

12. The system of claim 1, wherein the processor is further programmed to:
compare the minimum and maximum settlement amounts determined for the user with estimated minimum and maximum settlement amounts for other persons with similar transactional profiles in the data store; and
upon the estimated minimum and maximum settlement amounts for the user being different than the estimated minimum and maximum settlement amounts for other persons with similar transactional profiles by more than a determined threshold amount, re-estimating the minimum and maximum settlement amounts for the user.

13. The system of claim 1, wherein:
the data store stores two or more ongoing transactions records related to the user; and
the processor is further configured to aggregate amount for all of the ongoing transactions records related to the user, determine the maximum and minimum settlement amounts based on the aggregate amount, and determine a proposed settlement amount related to the aggregate amount.

14. The system of claim 1, wherein the data store stores demographic data related to the user.

15. The system of claim 1, wherein the data store stores consumer records for a plurality of persons.

16. A method for determining a periodic settlement amount related to an ongoing transaction using data and user interfaces distributed over an extranet, the method comprising:
receiving ongoing transaction data related to a user from a provider over the extranet;
receiving user records over the extranet;
determining maximum and minimum settlement amounts based on the ongoing transaction data and the user records;
determining a proposed settlement amount equal to or less than the maximum amount and equal to or more than the minimum amount;
generating a user interface;
transmitting, over the extranet, the user interface and the proposed settlement amount to the user; and
upon receiving confirmation of a settlement amount by the user over the extranet, transmitting the confirmed settlement amount to the provider.

17. The method of claim 16, further comprising:
determining a settlement term, the settlement term corresponding to the proposed settlement amount; and
if the confirmed settlement amount is different than the proposed settlement amount, modifying the settlement term in response to the confirmed settlement amount.

18. The method of claim 16, further comprising:
determining a range of settlement terms and a proposed settlement term, the range of settlement terms extending from a first length of time to a second length of time;
determining a proposed settlement term, the proposed settlement term being a period of time ranging from the first length of time to the second length of time;
transmitting the proposed settlement term over the extranet to the user receiving a confirmation of the proposed settlement term; and
if the confirmed settlement term is different than the proposed settlement term, re-determining the proposed settlement amount and transmitting the re-determined proposed settlement amount over the extranet to the user.

19. The method of claim 16, further comprising:
estimating outgoing transactions for the user;
wherein determining the maximum and minimum settlement amounts comprises determining the maximum and minimum settlement amounts based at least in part on the estimated outgoing transactions for the user.

20. A computer readable storage device embodying processor executable instructions that when executed provide for generating a user interface for handling ongoing transaction records and determining a periodic settlement amount related to the ongoing transactions, comprising:
receiving parameters related to a service provider;
receiving ongoing transaction records related to a user;
receiving user data, the user data including demographic data for the user and historical transactional data for the user;
receiving historical transactional data for other persons having similar demographic data to the user;
generating a maximum periodic settlement amount and a minimum periodic settlement amount based on the ongoing transaction records related to the user and the historical transaction data for the other persons;
generating a proposed periodic settlement amount based on the ongoing transaction records related to the user and the historical transaction data for the user between the maximum periodic settlement amount and the minimum periodic settlement amount;
generating a maximum settlement term, a minimum settlement term, and a proposed settlement term based on the maximum periodic settlement amount, the minimum periodic settlement amount, the proposed periodic settlement amount, and the parameters;
populating the user interface with an amount control based on the maximum periodic settlement amount, the minimum periodic settlement amount, and the proposed periodic settlement amount;
populating the user interface with a term control based on the maximum settlement term, the minimum settlement term, and the proposed settlement term;
transmitting the user interface to the user;
in response to receiving a user interaction with the amount control, transmitting an adjustment to the proposed settlement term to the user; and
in response to receiving a user interaction with the term control, transmitting an adjustment to the proposed settlement amount to the user.
